(19) United States
(12) Patent Application Publication
(10) Pub. No.: US 2005/0284125 A1
(43) Pub. Date: Dec. 29, 2005

(54) Hay rake with steering rear wheels

(76) Inventor: Adelmo Giovannini, Montecastelli (IT)

Correspondence Address: WILLIAM COLLARD;COLLARD & ROE, P.C., 1077 NORTHERN BOULEVARD, ROSLYN, NY, 11576, US

(21) Appl. No.: 11/151,603

(22) Filed: Jun. 13, 2005

(30) Foreign Application Priority Data
Jun. 14, 2004 (IT) RM2004U000101

(51) Int. Cl. A01D 76/00

(52) U.S. Cl. 56/366

(57) ABSTRACT

Hay rake towed by tractor or similar, able to perform changes of direction with a very narrow turning radius, carried out by use of steering rear wheels. In particular, the rear wheels steer in the opposite direction to those of the tractor and steering is controlled by mechanisms that can be activated actively and/or passively by the towing tractor.

### FIELD OF THE INVENTION

This invention refers to a hay rake with steering rear wheels, more precisely, to an appliance for agricultural use towed by a tractor, able to turn over hay, grass and similar cut products and to arrange these in regular windrows for subsequent collection, equipped with rear wheels counter-steering in relation to the tractor, to improve manoeuvrability of the hay rake.

### STATE OF THE ART

In agriculture, it is known that, after cutting grass, hay and similar, the material must be turned over to guarantee correct aeration thereof and then arranged in windrows to facilitate collection. Machines known as hay rakes including two horizontal arms equipped with collection wheels, generally arranged in a V-shape, are used for this purpose. Agricultural machines of this type are characterised by various drawbacks such as their considerable length and width. In order to restrict the problem of width, various solutions are known in this field tending, for example, to place the aforesaid horizontal arms parallel to the axis of the rake, in order to lift these to retract the collection wheels from the ground and to reduce the overall width, using for example telescopic elements.

None of the above solutions has been proposed so far as regards lengthwise dimensions, in particular, during in-field use of the machine. For example, considering that hay rakes may be more than ten meters long, the problems of manoeuvring these when working are evident; in particular, it is not possible to perform tight changes of direction at the end and at the corners of the field and, consequently, it is not possible (or at least it is very difficult) to overlap the zones effectively covered by the rake; therefore, it is not possible to work on more or less extensive areas with consequent loss of material or the need to adopt other solutions, for example further passages of the rake offset in relation to the first, or manual collection.

This invention aims to overcome such a drawback proposing a type of hay rake able to perform much tighter bends than possible to-date.

### SUMMARY OF THE INVENTION

The hay rake according to this invention includes a structure towed by a tractor or similar and a first longitudinal beam having a first end for attachment to the tractor and a second end connected with a second transversal beam provided, close to the ends thereof, with arms articulated on said ends, each arm being provided with a plurality of “star-shaped” wheels able to turn over and arrange in tidy windrows the hay, grass and the like previously cut and left on the field, characterised in that it comprises steering rear wheels located on the ends of the second transversal beam driven in their steering movement by specific means on the aforesaid second beam which are in turn activated by remote means located on the towing tractor.

The aforesaid means arranged on the second beam that act directly on the rear wheels of the hay rake to steer these (in the opposite direction to that of the tractor) consist of a bar parallel to the aforesaid second beam the ends of which are connected by means of rotating joints with gusset plates or protrusions each placed on a support rotating around an axis and on which the wheels are fitted. At least one of the aforesaid gusset plates or protrusions is connected to means able to rotate these around the axis of the rotating support; these means able to rotate the aforesaid gusset plates or protrusions may consist of a hydraulic cylinder, or a cable, or a bar.

The aforesaid remote means consist of a bar fastened to the rear part of the tractor (for example to the arms of the lifter of the tractor) provided, at its centre, with a first rotating joint connected to the first end of the beam and further provided with a second rotating joint, arranged at a certain distance from the first one, to which the aforesaid remote means that control the movement of the aforesaid means on the second beam are connected.

Said remote means may consist of a hydraulic cylinder joining the aforesaid second joint to a third joint located on the first beam, or of a rigid bar fitted between the aforesaid second joint and a third joint on the second transversal beam, in a lateral position in relation to the point at which this is joined to the first beam and connected to the aforesaid bar parallel to the second beam.

A further embodiment of the aforesaid remote means consists of a set of cables that connect a cam arranged on the bar fastened to the rear part of the tractor to similar cams fitted on the bar parallel to the second beam.

Lastly, it is possible that the hydraulic cylinder for direct control of the rotation of the steering wheels be controlled directly by the towing tractor, connecting the hydraulic connection ducts directly to means controlled by the tractor.

### BRIEF DESCRIPTION OF THE DRAWINGS

This invention will now be described in greater detail in relation to the attached drawings, where:

FIG. 1A is a schematic top view of a hay rake and of the related tractor towing this, in a position of straight line travel;

FIG. 1B is a similar view, showing the tractor turning to the left;

FIG. 1C is a similar view to that of FIG. 1B, but with the tractor turning to the right;

FIG. 2A is a partial view of the first longitudinal beam of the rake, connected to a bar integral with the tractor, for example to the lifting arms of the tractor, beam and bar being connected to a hydraulic cylinder, in the condition in which tractor and rake proceed in a straight line;

FIG. 2B is a similar view to 2A, but with the tractor steering to the left;

FIG. 2C is a similar view but with the tractor steering to the right;

FIG. 3 is a schematic view of the hay rake, similar to FIG. 1A, but in greater detail and with the steering system of the rear wheels controlled by hydraulic cylinders;

FIG. 4 is a schematic view of the hay rake, similar to FIG. 1A, but in greater detail and with the steering system of the rear wheels controlled by a rigid bar;

FIG. 5 is a schematic view of the hay rake, similar to FIG. 1A, but in greater detail, and with the steering system of the rear wheels controlled by flexible cables.

FIG. 6 is a schematic view of the hay rake, similar to FIG. 1A, but in greater detail, and with the steering system of the rear wheels controlled by an hydraulic cylinder.

### DETAILED DESCRIPTION OF THE INVENTION

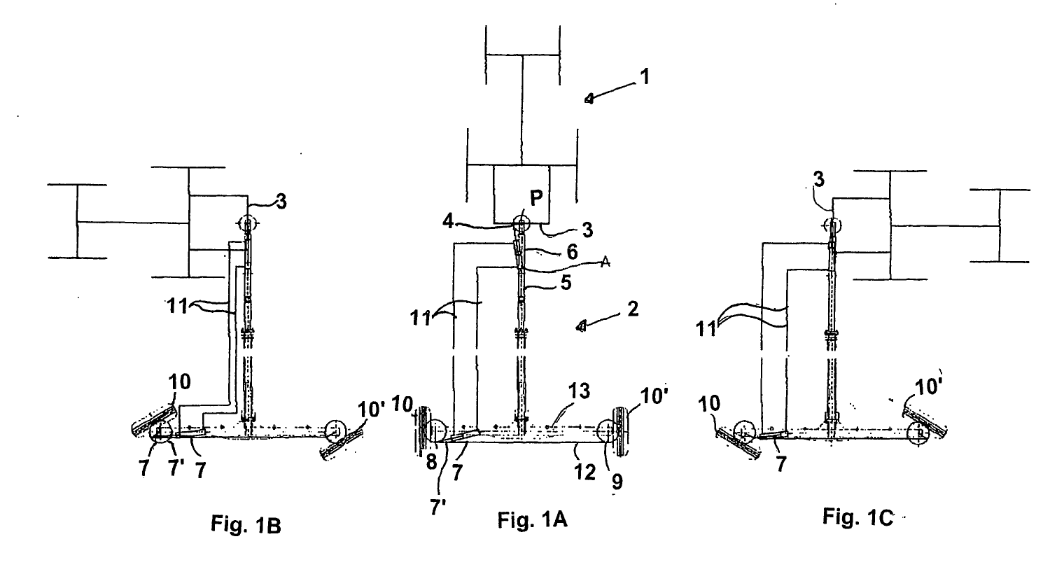

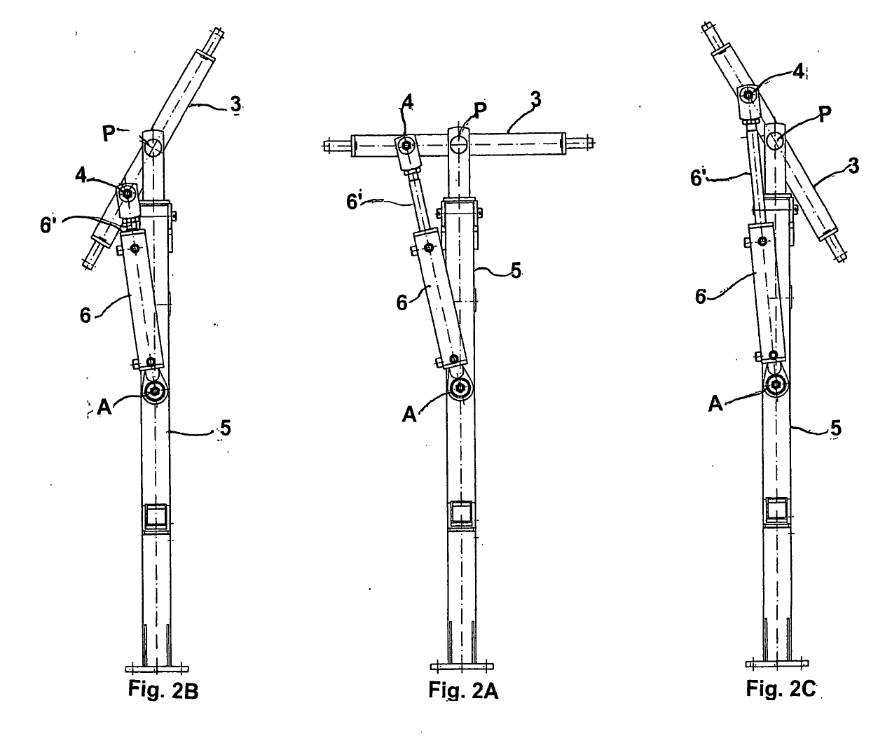

Referring to FIG. 1A, it can be seen that the tractor, indicated generally with 1, has, to the rear, a bar 3 (that may be connected to lifter arms BS, BS′ of the tractor), at the centre of which the first beam 5 of the hay rake, generally identified with 2, pivots in P. On bar 3, to the side of point P, a hydraulic cylinder 6, fastened to the first beam 5 at point A, is hinged in 4. Ducts 11 connect the hydraulic cylinder 6 to a second hydraulic cylinder 7, one end of which is fastened to the second transversal beam 13 while the other is connected to an arm or gusset plate 8 protruding perpendicularly in relation to a bar 12 and in relation to an axis (not indicated) of rotation of the wheel 10. This bar 12 is also connected to a further arm or gusset plate 9, similar to that indicated previously with 8, integral with the axis of rotation (not shown) of the wheel 10′. When the tractor swerves, for example to the left (FIG. 1B; FIG. 2B), bar 3 rotates in the direction of steering of the tractor, causing point 4 to move close to point A, with therefore retraction of the rod 6′ in the hydraulic cylinder 6, whose hydraulic fluid moves and, flowing in ducts 11, activates the hydraulic cylinder 7, pushing rod 7′ out of this; this rod 7′ pushes the arm or gusset plate 8 and causes rotation of the wheel 10′. A bar 12 provides integral connection of arm 8 to another arm 9 connected to the axis of rotation (not shown) of the wheel 10′; the movement of rotation of the arm 8, caused by activation of the hydraulic cylinder 7, moves the bar 12, which moves the arm 9 and causes rotation also of wheel 10′. A similar situation occurs when the tractor (FIG. 1C) turns to the right.

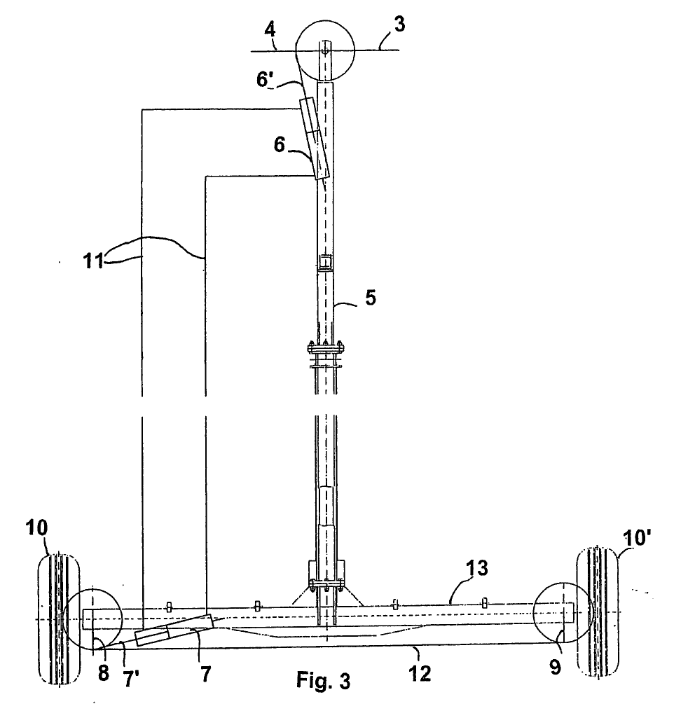

FIG. 3 shows, in further detail, the connection diagram between cylinder 6, cylinder 7 and gusset plates 8 and 9 made integral by bar 12 and also illustrates more clearly the system of activation of the steering rear wheels.

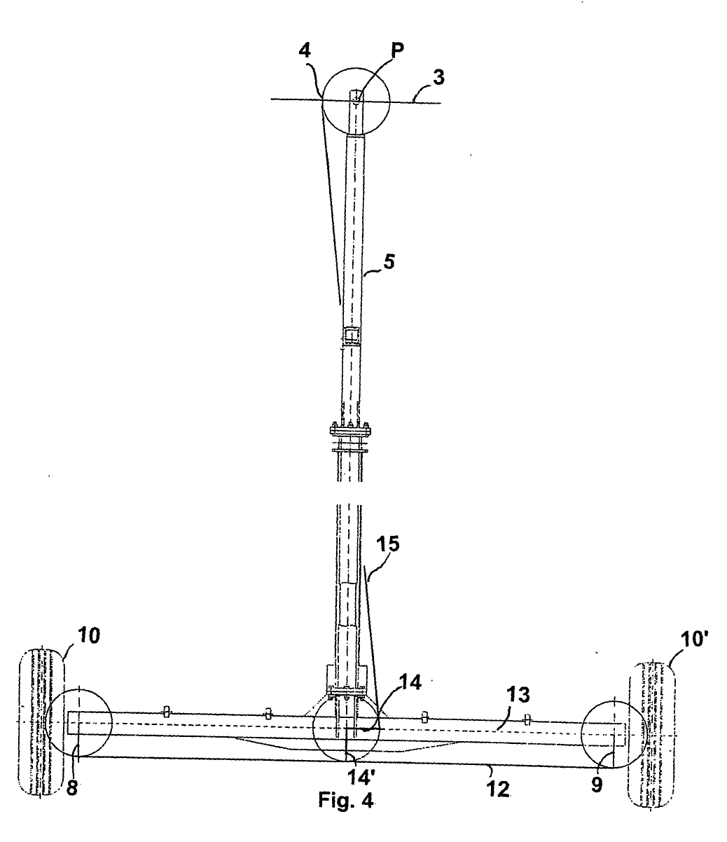

FIG. 4 shows a variant of the control system of the movement of the rear wheels. In this variant, a rigid bar 15 pivots at point 4 and connects this point to one end of a rotating arm or gusset plate 14 pivoted so that it can rotate around an axis passing through a point located at the centre of beam 13. A second arm or gusset plate 14′ protrudes at 90° from arm 14, is integral with this and is connected so as to rotate at the centre of bar 12. If the tractor turns, bar 13 is pushed or pulled by the movement of point 4, causes similar rotation of arm 14 which, in turn, causes movement of arm 14′ which, moving bar 12, causes steering of wheels 10, 10′.

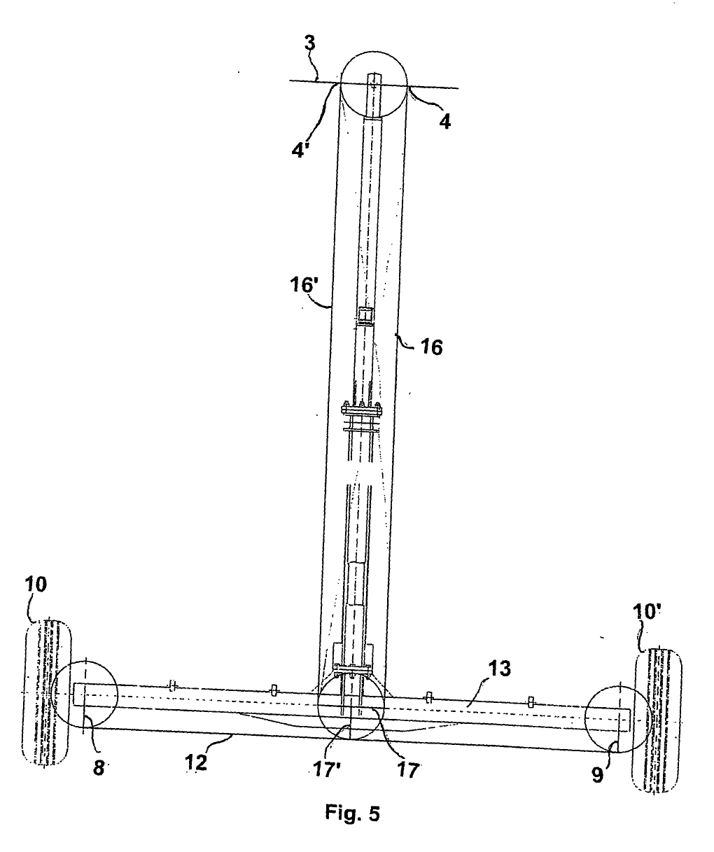

FIG. 5 shows another control variant, in which ropes 16, 16′ made integral at points 4, 4′ with the bar 3 connect this to an arm 17 pivoted so as to rotate around an axis passing through a point located at the centre of beam 13. While it rotates, arm 17 pulls with it arm 17′, which is integral with this and then bar 12 causing in this way steering of wheels 10, 10′.

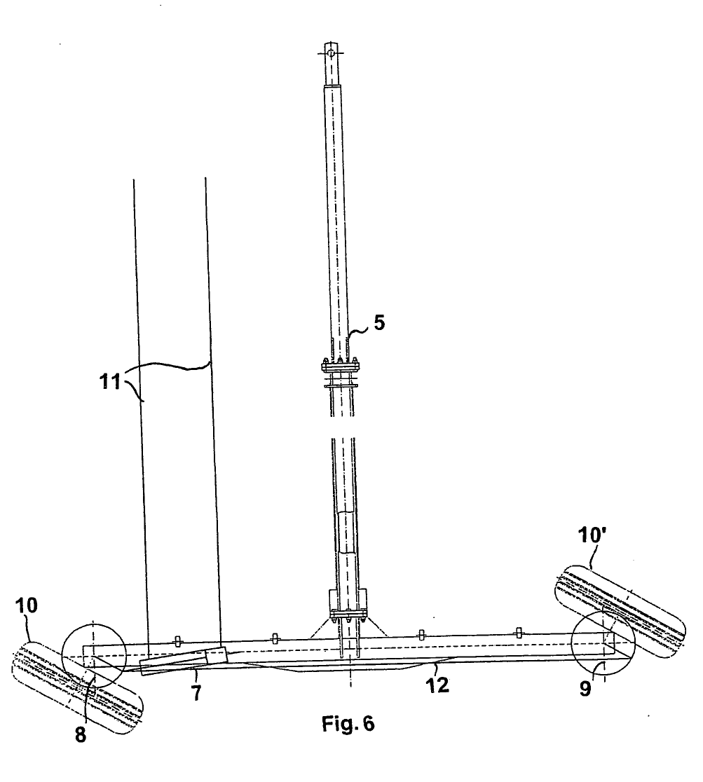

FIG. 6 represents a method of functioning that uses an hydraulic cylinder 7 to activate arms 8, 9 that steer the rear wheels 10, 10′, with ducts 11 for transfer of the hydraulic fluid that lead to a hydraulic control located directly on the tractor, for example on its steering system.

1. Hay rake consisting of a structure towed by a tractor or similar and a first longitudinal beam having a first end for attachment to the tractor and a second end connected with a second transversal beam provided, close to the ends thereof, with arms articulated on such ends, each arm being provided with a plurality of “star-shaped” wheels able to turn over and arrange in tidy windrows the hay, grass and the like previously cut on the field, characterised in that it comprises steering rear wheels located on the ends of the second transversal beam driven in their steering movement by specific means on the aforesaid second beam which are in turn activated by remote means located on the towing tractor.

2. Hay rake according to claim 1, wherein the aforesaid means arranged on the second beam and acting directly on the rear wheels of the hay rake to steer these consist of a bar parallel to the aforesaid second beam and of arms or gusset plates, integral with the ends of said bar and each integral with a support rotating around an axle with the wheels.

3. Hay rake according to claim 2, wherein at least one of said arms or gusset plates is connected to means able to cause rotation thereof around the axis of the rotating support; such means able to rotate said gusset plates consisting of a hydraulic cylinder.

4. Hay rake according to claim 2 wherein at least one of said arms or gusset plates is connected to means able to rotate these around the axis of the rotation support; such means able to transmit rotation to such gusset consisting of a cable.

5. Hay rake according to claim 2 wherein at least one of said arms or gusset plates is connected to means able to rotate these around the axis of the rotation support; such means able to transmit rotation to such gusset plates consisting of a bar.

6. Hay rake according to claim 1 wherein said remote means consist of the set of a bar fastened to the rear part of the tractor with, in its centre, a first rotating joint connected to the first end of the beam and also with a second rotating joint, arranged at a certain distance from the first and of further means of activating the means fitted on said second beam, for control of the steering wheels.

7. Hay rake according to claim 6 wherein said remote means consists of a hydraulic cylinder joining the aforesaid second joint to a third joint located on the first beam.

8. Hay rake according to claim 6 wherein said remote means may consist of a rigid bar arranged between said second joint and a third joint arranged on the aforesaid second crosswise beam, to the side in relation to the point where this is joined with the first beam and connected to said parallel bar to the second beam.

9. Hay rake according to claim 6 wherein said remote means may consist of a set of cables that connect a cam fitted on the bar fastened to the rear part of the tractor to similar cams fitted on the bar parallel to the second beam.

10. Hay rake according to claim 1 wherein said remote means consist of means controlled directly by the tractor.
